(19) United States
(12) Patent Application Publication
(10) Pub. No.: US 2013/0124060 A1
(43) Pub. Date: May 16, 2013

(54) HYDRAULIC BRAKING SYSTEM CONTROL IN AUTOMOTIVE VEHICLES

(71) Applicants: Thomas SVENSSON, Leichlingen (DE); Ian MOORE, Pulheim (DE)

(72) Inventors: Thomas SVENSSON, Leichlingen (DE); Ian MOORE, Pulheim (DE)

(73) Assignee: FORD GLOBAL TECHNOLOGIES, LLC, DEARBORN, MI (US)

(21) Appl. No.: 13/656,603

(22) Filed: Oct. 19, 2012

(30) Foreign Application Priority Data
Oct. 19, 2011 (DE) 102011084746.4

(51) Int. Cl. B60T 8/171; B60T 13/14

(52) U.S. Cl. CPC B60T 8/171; B60T 13/142
USPC 701/70

(57) ABSTRACT

A hydraulic braking system for a vehicle incorporating a vehicle dynamics control system (VDCS) includes an electromechanically actuated brake master cylinder that hydraulic braking system detects a reduction in the brake pressure of the wheel brake device, caused due to intervention of the VDCS in the braking operation, and moves a piston of the brake master cylinder in a direction opposite to an actuating direction. This causes an additional flow of the brake fluid from a reservoir to one or more pressure chambers of the brake master cylinder, thus, avoiding the piston from reaching a stop condition, and hence, avoiding an inadequacy in the volume of the brake fluid available in the pressure chambers of the brake master cylinder.

### TECHNICAL FIELD

Embodiments of the present disclosure generally relate to braking systems in automotive vehicles, and more specifically, to methods for controlling automotive vehicle hydraulic braking systems.

### BACKGROUND

Many conventional automotive vehicles have hydraulic braking systems, which may be dual-circuit braking systems. Hydraulic braking systems generally have a brake master cylinder, with a piston connected to a brake pedal of the vehicle through a push rod. Pressure within the cylinder is produced by a piston acting on hydraulic fluid, which pressure is then transmitted through brake lines to one or more brake shoes. Responsive to the applied pressure, brake pads carried on the shoes are pressed into contact with the vehicle's brake drum or the brake disc. In this manner, a braking force is applied to the wheels, activated by the driver pressing on the brake pedal.

Many conventional brake master cylinders are designed as tandem brake master cylinders (TMC), having two pressure chambers arranged in series, separated by a secondary piston. This arrangement generates pressure in two independent brake circuits. For intensifying the braking operation in such cylinders, a brake booster is connected to the piston rod, for producing an additional braking force upon the actuation of brake pedal. This additional braking force increases the braking pressure either pneumatically, by means of a vacuum source, or electronically, through an electric motor collaborating with an actuator mechanism.

In many situations, frequent or heavy use of the brakes can cause the brake drum or disk to you, which in turn produces additional heating throughout the braking system. When that heating occurs, a relatively greater quantity of brake fluid is displaced from the brake master cylinder, to achieve a required amount of retardation. In that event, a situation may arise in which one or more master cylinder pistons may move to their respective limits of travel, precluding any further movement. This condition is referred to as “TMC bottom out.” As a consequence, no further pressure build up within the brake master cylinder is possible, and thus the vehicle braking distance is substantially increased.

The “TMC bottom out” problem occurs particularly in vehicles which incorporate Vehicle Dynamic Control Systems (VDCS) for braking VDCS systems use an Anti-lock Braking system (ABS) collaborating with an Electronic Stability Control system (ESC). Those in the art understand that an ABS prevents the wheels from locking up, which in turn reduces the braking distance. The ABS generally includes an electronic control unit and wheel speed sensors coupled to each wheel of the vehicle. Through these sensors, the electronic control unit (ECU) continuously monitors the rotational speed of each wheel, to detect conditions of an impending wheel lock. If such a condition is detected, the ECU reduces the brake pressure at the affected wheel, to prevent the wheel from locking It has been noted, however, that pressure build up in VDCS may also lead to a situation in which the master cylinder reaches an extreme position (i.e., a stop condition).

Attempts have been made in the art to avoid situations where the piston of the brake master cylinder reaches its stop position. One effort in this direction has been to feed additional brake fluid into the pressure chambers of the brake master cylinder, through hydraulic pumps or pressurized tanks. Alternatively, a hydraulic pressure supply unit may supply hydraulic pressure for the braking system, based on an increase or decrease in pressure within wheel brake cylinders. However, most of these methods and systems are expensive.

Accordingly, a need remains for a method that can avoid an increase in the stopping distance of a vehicle having a hydraulic braking system and a VDCS, stemming from a condition in which one or more pistons of a brake master cylinder of the vehicle reaches a stop condition (i.e., an extremity), due to excessive displacement of the brake fluid from the pressure chambers of the brake master cylinder.

### SUMMARY

The present disclosure provides controls for the hydraulic braking system of an automotive vehicle incorporating a vehicle dynamics control system (VDCS), to avoid conditions of a lack of brake fluid within the pressure chamber of the brake master cylinder of the braking system.

In one aspect, the disclosure provides a controlling method for a hydraulic braking system of a vehicle, incorporating a vehicle dynamics control system. The braking system includes an electromechanically actuated brake master cylinder, which fluidly communicates with a wheel brake device of the vehicle. The wheel brake device is actuated by the vehicle dynamics control system. The method detects a reduction in the brake pressure in the wheel brake device, due to an intervention of the vehicle dynamics control system in the braking operation. If detected, the method moves a piston of the brake master cylinder opposite to an actuating direction, to allow an additional flow of a brake fluid from a reservoir to the pressure chambers of the brake master cylinder.

According to another aspect, the present disclosure provides a vehicle having a hydraulic braking system, which includes a brake master cylinder and a wheel brake device that fluidly communicates with the brake master cylinder. A vehicle dynamics control system (VDCS) is coupled to, and actuates the wheel brake device. The system further includes a means for detecting a reduction in the brake pressure of the wheel brake device caused to the VDCS acting on it. Further, a control device actuates the brake master when the reduction in the brake pressure is observed, by moving a piston of the brake master cylinder in a direction opposite to a direction in which the piston moved earlier, caused due to the reduction in the brake pressure of the wheel brake device.

Additional aspects, advantages, features and objects of the present disclosure would be made apparent from the drawings and the detailed description of the illustrative embodiments construed in conjunction with the appended claims that follow.

### BRIEF DESCRIPTION OF THE DRAWINGS

FIG. 1 shows a method for controlling a hydraulic braking system of an automotive vehicle, in accordance with the present disclosure.

### DETAILED DESCRIPTION

The following detailed description illustrates aspects of the disclosure and the ways it can be implemented. However, the description does not define or limit the invention, such definition or limitation being solely contained in the claims appended thereto. Although the best mode of carrying out the invention has been disclosed, those in the art would recognize that other embodiments for carrying out or practicing the invention are also possible.

The present disclosure relates to a method and a system for controlling the hydraulic braking system of a vehicle, incorporating a vehicle dynamics control system (VDCS). Those skilled in the art will understand that a hydraulic braking system generally includes a brake master cylinder coupled to different wheel brake cylinders of the vehicle, through different hydraulic lines. The brake master cylinder may be electromechanically actuated and is in fluid communication with a wheel brake device. Further, a brake booster is coupled to the brake master cylinder to provide additional braking force when required. The vehicle brake pedal operates a push rod, which is coupled to a piston carried within the brake master cylinder. Thus, the push rod drives the piston in response to actuation of the brake pedal. In turn, the piston exerts pressure upon hydraulic brake fluid contained in the pressure chambers of the brake master cylinder, and the pressurized brake fluid at the end of this change wheel brake cylinders, through the hydraulic fluid lines. Eventually, the brakes are actuated, slowing the vehicle or bringing it to a halt.

In an embodiment, the brake master cylinder may also be a tandem brake master cylinder (TMC) having a dual circuit braking system. In this arrangement, the master cylinder has two pressure chambers arranged in series, connected by a secondary piston.

Each wheel brake device includes brake shoes or pads configured to push against the brake drum or a brake disc, respectively, coupled to each wheel. When the brake master cylinder is actuated, the hydraulic pressure in the brake system increases, causing the brake shoes or pads to press push more firmly against the brake drum or the brake disc.

The vehicle dynamics control system (VDCS) intervenes in the hydraulic braking process in certain driving conditions. Most notably, the VDCS detects and ameliorates wheel slip conditions. A conventional VDCS includes an anti-lock braking system (ABS), which prevents wheel lockup by detecting and correcting for that condition, thus reducing a vehicle's s braking distance. The ABS includes an electronic control unit (ECU) and wheel speed sensors coupled to each wheel. Through the wheel speed sensors, the electronic control unit (ECU) continuously monitors the rotational speed of each wheel, to detect an impending wheel lockup. If such a condition is detected, the ECU reduces the brake pressure on the affected wheel, maintaining at least minimal wheel rotation and thus preventing lockup. The braking force acting on the different wheels of the vehicle can be controlled and modified by actuating one or more hydraulic valves, if a brake pressure reduction is required (i.e., when the wheels lock), or, by actuating a brake master cylinder, if an increase in the brake pressure is required.

According to the present disclosure, in a case where the VDCS intervenes in the braking operation to reduce the brake pressure of the wheel brake device, the piston of the brake master cylinder is moved in a direction opposite to the direction in which it was actuated to move by the VDCS (the “actuation direction”), causing a reduction in brake pressure. The movement of the piston opposite to the actuation direction allows an additional amount of brake fluid to flow into one or more pressure chambers of the brake master cylinder.

In an embodiment, a brake fluid reservoir connected to the pressure chambers of the brake master cylinder routes the flow of brake fluid within the pressure chamber. This routing is triggered by a negative pressure created within the pressure chambers due to the movement of the piston in the actuation direction. Further, the piston is moved opposite to the actuation direction, to a point where it was initially activated to move in the actuation direction by the VDCS, to ensure that an adequate amount of brake fluid is routed back to the pressure chambers of the brake master cylinder, thus avoiding a brake fluid scarcity within the pressure chambers. In that manner, the present disclosure automatically replenishes the brake fluid in the brake master cylinder pressure chambers. Further, since the piston of the brake master cylinder is retracted against the actuation direction, a situation where the piston reaches its extreme position (i.e., stop condition, or the “TMC bottom out” condition, as mentioned earlier) is avoided. Absent that action TMC bottom out condition may have otherwise eventually resulted into substantially low brake fluid in the pressure chamber. Also, a further ‘pressure build up condition’ through the brake master cylinder is avoided. Such a situation where the piston may reach its extreme position is generally more prevalent in cases where the service brakes of the vehicle heat up, or, when there is sudden abruptly increased requirement of the brake fluid due to interventions from the vehicle dynamics control system (VDCS) of the hydraulic braking system.

To facilitate movement of the brake master cylinder piston, against the actuation direction, a control device may be provided to act as an integral component of the hydraulic braking system, and that control device may include a processor coupled to different pressure sensors attached to the wheels of the vehicle. The processor, on receiving signals corresponding to a reduction in the brake pressure within the wheel brake device, from the pressure sensors, may initiate the movement of the piston against the actuation direction.

In a preferred embodiment, when a repeated reduction in the brake pressure within the brake master cylinder is required, due to frequent interventions by the VDCS, the piston of the brake master cylinder is repeatedly moved opposite to the actuation direction. Specifically, the piston may be retracted each time when a reduction in the brake pressure is observed. This allows a repeated flow of a certain additional volume of the brake fluid into the pressure chambers of the brake master cylinder. Consequently, even in cases pertaining to repeated braking cycles, or, repeated braking interventions cycles from the VDCS, the system ensures that a sufficient volume of brake fluid remains within the brake master cylinder. In this manner, sufficiently high brake pressure generation can always be obtained through actuation of the brake master cylinder, under any situation.

In an embodiment, the control method of the present disclosure detects a travel distance of the piston of the brake master cylinder during intervention of the VDCS. Further, the method also detects an adjustment angle of an actuating mechanism for the brake master cylinder. Preferably, the brake master is electromechanically actuated, and the actuation mechanism includes an electromechanical actuator engaging the push rod (i.e., the piston rod) of the brake master cylinder. The electromechanical actuator may include an electric motor, coupled to a mechanism that converts the rotary motion of the electric motor into the linear motion of the piston rod. A rotary encoder coupled to the actuating mechanism for the brake master cylinder detects the adjustment angle. Further, those in art will understand that one or more sensors coupled to the piston of the brake master cylinder can detect its travel distance, as the VDCS intervenes in the braking operation.

In one embodiment, the piston is moved against the actuation direction only if the travel distance for the piston exceeds a pre-determined threshold distance value, and/or the adjustment angle for the actuating mechanism exceeds a pre-determined threshold angular value. This provision ensures that the movement of the piston opposite to the actuation direction is initiated only in a case where the piston has reached its extreme position, or the stop condition for the piston (i.e., the “TMC bottom out” condition) has been achieved. This measure also ensures that the disclosed method is implemented in a manner having only an imperceptible effect on the driver and occupants of the vehicle. Further, the determination of the threshold distance value, and the pre-determined threshold angular value is based on certain parameters, including the size and the dimensions of the brake master cylinder, the mechanical components co-acting with the master cylinder, including the actuating mechanism, to make sure that a sufficient volume of brake fluid is maintained in the pressure chambers at all times.

The pressure sensors coupled to the vehicle wheels generate signals to facilitate detection of any reduction in brake pressure within the brake master cylinder. Such pressure sensors are well known in the art, and are normally provided within the vehicle dynamics control systems (VDCS) of vehicles equipped with hydraulic braking systems. Specifically, for example, the pressure sensors may generate signals indicative reduction in brake pressure under excessive wheel slip conditions occurring at any of the wheels of the vehicle.

In a preferred embodiment, the method of the present disclosure activates movement of the piston of the brake master cylinder opposite to the actuation direction only if: any of the pressure sensors detects an excessive wheel slip condition, the travel distance for the piston exceeds the pre-determined threshold distance value, and/or the adjustment angle for the actuating mechanism of the brake master cylinder exceeds the pre-determined threshold angle value.

In one embodiment, the claimed invention further detects variation in the thickness of the brake disks of the wheel brake devices, through the signals obtained from the pressure sensors coupled to the different wheels of the vehicle. Such a variation in the brake disk thickness can arise due to certain factors, for example, from a non-uniform wear of the brake disk, and this variation can increase with time, due to ongoing contact between the brake pads and the brake disk. When the vehicle's brakes are actuated, the variation in the thickness of the brake disk can lead to perceptible juddering of the motor vehicle. Such juddering can be easily perceptible, and can also lead to impairing of the running characteristics of the vehicle. The non-uniform brake disk thickness is evident especially from a variation in the brake pressure of the wheel brake device, which can be detected by the pressure sensor, e.g. from a periodic variation in the sensor signal at the wheel frequency. Due to the fact that a variation in the brake disk thickness is detected from the signal of the pressure sensor, it is possible to initiate countermeasures or to output a warning signal, for instance.

In one embodiment, upon detecting a variation in the brake disk thickness of the brake disc, the method of the present disclosure performs an automatic actuation of the wheel brake device, to reduce or avoid an increase in the variation beyond a limit. For that effect, the wheel brake device can be activated at a frequency corresponding to the wheel frequency or the frequency of the brake disk thickness variation and with a corresponding phase shift relative to the thickness variation. This action may counteract any further increase in brake disk thickness variation.

Further, in some embodiments, the automatic actuation of the wheel brake device to reduce the observed increase in the variation of the brake disk thickness is preferably performed when a minimum variation amplitude of the brake pressure detected by the pressure sensor, or a minimum variation amplitude of the brake disk thickness is exceeded.

In one embodiment, the minimum variation amplitude of the brake pressure can be about 2 bar, for example. This ensures that the automatic actuation of the wheel brake device avoids any perceptible braking effect, and hence, does not unnecessarily intervene when the vehicle is smoothly driven.

In particular, the periodically variable brake pressure produced by automatic actuation of the brake master cylinder is dependent on the pressure variation measured by the pressure sensor coupled to the wheel brake device. If Pᵥₐᵣ denotes the amplitude and Fᵥₐᵣ denotes the frequency of the measured pressure variation within the wheel brake device, then the following equations are used to calculate the amplitude P_{var,TMC} and frequency F_{var,TMC} of the periodically variable pressure produced by automatic actuation of the brake master cylinder:

$$\begin{matrix}{P}_{var , TMC} = \frac{{P}_{var}}{x} & 1 ) \\ {F}_{var , TMC} = \frac{{F}_{var}}{y} & 2 )\end{matrix}$$

wherein;

1>x>10; and, 1>y>40.

Specifically, x is a number between 1 and 10 and y is a number between 1 and 40.

Using these equations to calculate the amplitude and frequency of brake pressure variation, a reasonable compensation of the braking force variations produced by the brake disk thickness variation can be achieved, to avoid juddering within the vehicle, beyond a certain extent.

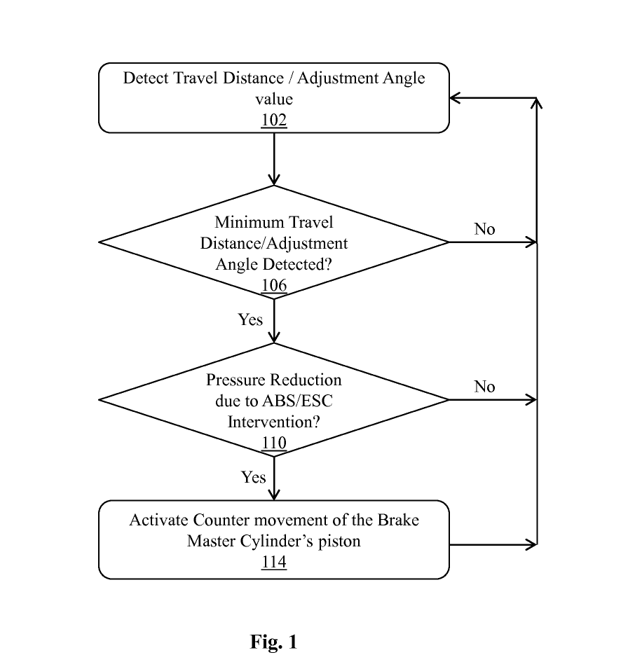

FIG. 1 illustrates a method for controlling the hydraulic braking system of an automotive vehicle, in accordance with the present disclosure. At step 102, the method detects a distance traversed by the piston of the brake master cylinder, as well as the adjustment angle for the actuating mechanism of the brake master cylinder. As noted earlier, this step is taken when a reduction in the brake pressure at the wheel brake device is observed. At step 106, the method checks whether the travel distance and/or the adjustment angle have exceeded the pre-determined threshold distance value and the threshold angle value, respectively. If so, then at step 110, the method identifies whether the vehicle dynamic control system (VDCS) has intervened in the braking operation. The intervention may specifically be due to an ABS acting through an electronic stability control, these being integral components of the VDCS. If not, then the method loops back to step 102, and continues detecting the travel distance for the piston and/or the adjustment angle for the actuating mechanism. Else, if the intervention of the VDCS is identified, the method activates the movement of the piston of the brake master cylinder, in a direction opposite to the actuation direction, as noted above. The brake booster coupled to the brake master cylinder of the hydraulic braking system, can be used to retract the piston in the direction opposite to the actuation direction. Further, the piston is retracted to a level where the minimum pre-determined threshold distance value or the threshold adjustment angle value for the actuating mechanism for the brake master cylinder, are undershot again. In this manner, the method of the present disclosure avoids the piston of the brake master cylinder from being in a stop condition, i.e., the TMC bottom out condition, thus ensures that the amount of brake fluid is maintained in the pressure chambers thereof, sufficient to supply an additional braking force, whenever desired.

The method and the system of the present disclosure can be implemented within any automotive vehicle having a hydraulic braking system, and incorporating a vehicle dynamics stability control therein, including cars, SUVs, trucks, etc.

Although the current invention has been described comprehensively, in considerable detail to cover the possible aspects and embodiments, those skilled in the art will recognize that other versions of the invention are also possible.

What is claimed is:

1. A method for controlling a hydraulic braking system of a vehicle, incorporating a vehicle dynamics control system (VDCS), the braking system comprising an electromechanically actuated brake master cylinder fluidly communicating with a wheel brake device of the vehicle, the wheel brake device being configured to be actuated by the vehicle dynamics control system, the method comprising:
detecting a reduction in the brake pressure in the wheel brake device, and
moving a piston of the brake master cylinder opposite to an actuating direction, to allow an additional flow of a brake fluid from a reservoir to one or more pressure chambers of the brake master cylinder.

2. The method of claim 1, further comprising, during a reoccurrence of reduction in the brake pressure in the wheel brake device, moving the piston of the brake master cylinder again, during each reoccurrence, to facilitate successive additional flows of the brake fluid in the one or more pressure chambers of the brake master cylinder.

3. The method of claim 1, further comprising:
detecting at least one of a travel distance of the piston of the electromechanically actuated brake master cylinder, and an adjustment angle of an actuating mechanism of the brake master cylinder; and
moving the piston opposite to the actuation direction if at least one of the travel distance exceeds a pre-determined threshold distance value and the adjustment angle exceeds a pre-determined threshold angle value.

4. The method of claim 1, further comprising, detecting the reduction in the brake pressure through a pressure sensor coupled to the wheel brake device of the vehicle.

5. The method of claim 4, wherein the wheel brake device includes a brake disc, the method further comprising, detecting a variation in the brake disc thickness of the vehicle through a pressure sensor.

6. The method of claim 5, further comprising, actuating the wheel brake device, to minimize an increased variation in the brake disc thickness, on detection of the variation.

7. The method of claim 6, further comprising, actuating the wheel brake device when an amplitude of variation of the brake disc thickness exceeds a pre-determined level.

8. The method of one of claims 6 and 7, further comprising, superimposing a periodically variable pressure produced by the automatic actuation of the brake master cylinder, on a brake pressure of the wheel brake device, to achieve a desired braking effect.

9. The method of claim 8, further comprising, calculating an amplitude (P_{var, TMC}) and frequency (F_{var, TMC}) of the periodically variable pressure produced by the automatic actuation of the brake master cylinder pressure, and an amplitude (Pᵥₐᵣ) and frequency (Fᵥₐᵣ) of the variation in pressure produced by the wheel brake device, using the following equations:
P_{var, TMC}=Pᵥₐᵣ/x;
and
F_{var, TMC}=Fᵥₐᵣ/ y,
wherein
‘x’ is a number having value in the range of 1 to 10, and ‘y’ is a number having a value in the range of 1 to 40.

10. The method of claim 1, further comprising, moving the piston opposite to the actuation direction, includes moving it to a position from where it was earlier actuated to move, to cause the reduction in the brake pressure due to the vehicle dynamics control system.
